(19) United States
(12) Patent Application Publication
(10) Pub. No.: US 2003/0092793 A1
(43) Pub. Date: May 15, 2003

(54) Process for the preparation of biodegradable resin

(75) Inventors: Jiafan Liu, Tianjin (CN); Shipu Quan, Tianjin (CN)

Correspondence Address: STERNE, KESSLER, GOLDSTEIN & FOX PLLC, 1100 NEW YORK AVENUE, N.W., SUITE 600, WASHINGTON, DC, 20005-3934, US

(73) Assignee: TIANJIN DANHAI CO., LTD

(21) Appl. No.: 10/187,850

(22) Filed: Jul. 3, 2002

(30) Foreign Application Priority Data
Nov. 15, 2001 (CN) 01134820.8

(51) Int. Cl. C08K 3/00

(52) U.S. Cl. 523/124; 524/47

(57) ABSTRACT

Disclosed is a process for preparation of biodegradable resin. The process comprises dehydrating a starch in a dehydrating kettle to a moisture less than 0.5%; finely granulating the dehydrated starch slurry to an average granule size below 10 μm; centrifuging the starch slurry to obtain a filter cake; adding to the centrifuged starch 0.5-5 wt % of a coupling agent and 0.5-7.5 wt % of a lubricant, based on the weight of dehydrated starch for modification; feeding the modified starch, 25-80 wt % of a thermoplastic resin, 1-10 wt % of a plasticizing agent, 0.5-7.5 wt % of a lubricant and 1-15 wt % of a degradation promoter, based on the weight of dehydrated starch, into a mixer and mixing them for 10-30 minutes under stirring, and then discharging them; extrusion-pelletizing the discharged material via a twin-screw extruder, the screws of which have length to diameter ratio of 40-48:1 and are of degassing function, at a temperature of 100-290° C. The advantages of the present invention reside in widely available raw materials, simple process technology, easy industrial practice, low production cost and excellent biodegradability of the biodegradable resin.

### TECHNICAL FIELD OF THE INVENTION

This invention relates to resin preparing field, more particularly to a process for the preparation of biodegradable resin.

### BACKGROUND OF THE INVENTION

Along with the rapid development of industrial technology of polymer material, while plastic and non-woven fabric articles are widely used in a variety of fields of production and people's daily life, waste materials therefrom have also been increased progressively. There is a data showing that the weight ratio of plastic and non-woven fabric articles in solid waste materials of city, has been more than 10% and the volume ratio of them has been 30%, in which most of them are disposable packages and commodities. Since common plastic and non-woven fabric material are difficult to be degraded and rotted after use in natural environment, and the cost for collecting and separating them is too high, they are hard to be widely utilized or the “white-pollution” is inevitably resulted, which has become an important global task for preventing and controlling the environmental pollution. At present, many countries in the world have, on one hard, constituted strict policies or regulations to reduce said environmental pollution, on the other hard, advocate and support the study and development in degradable materials.

Degradable material, as a high technology and environmental protecting product, has been a highlighted research and development field in the world. The development of this technology not only broadens the function of common polymer material, but also alleviates the contradiction between using common polymer material and protecting environment, which possesses very broad commercial prospects. The starch/resin composite biodegradable resin is an important research direction.

Up to now, there are few of reports relating to the treatment of starch dehydrating and fine-granulating. WO95/04082 discloses heat treated noncohesive starches and flours and process for their production, in which the fluidized bed is used to dehydrate starch to a moisture content of less than 5% by weight. U.S. Pat. No. 5,929,231 discloses a method for preparing fine-granuled and modified starches from oats and rice, in which oats and rice starches with primary granule size of 5-10 μm are milled into particles with average granule size of 3-5 μm. U.S. Pat. No. 5,667,574 discloses a starch-based composition for preparing an environment degradable alpha-olefinic polymer molding material, in which it describes a method for the preparation of a starch-based master batch, comprising mixing 95-99 parts by weight of starch, 0.2-0.8 parts by weight of a titanate coupling agent, 0-2 parts by weight of paraffin and 0-2 parts by weight of fatty acid; and mixing and kneading 50-80 parts by weight of the resultant mixture with 18-49.8 parts by weight of alpha-olefinic polymer, 0.1-1.0 parts by weight of a photosensitizer and 0.1-1.0 parts by weight of a photosensitizer promoter at a temperature of 120-10° C. for 5-10 minutes, then cooling and pelletizing the resultant molten mixture to obtain said master batch. The resultant environment degradable alpha-olefinic polymer molding material can be prepared by using said starch-based master batch via a conventional compounding process, and the molding material can be used to make bags, bottles, foamed sheets and films, etc., with conventional plastic molding techniques.

### DESCRIPTION OF THE INVENTION

The present invention utilized a novel starch treatment process comprising dehydrating starches in liquid phase, finely granulating in multiple stages and modifying the starches, to make the starches miscible with a variety kinds of resins. The biodegradable resin produced by the process according to the present invention has good quality, with the content of starch up to 70 wt % of the composite resin. The process can be used in continuous production and easily controlled. The products obtained from this process have no air and water bubbles, with excellent quality and biodegradability.

An object of the present invention is to provide a continuously running, ten-thousand-tons-scale industrial and widely used process for the preparation of a biodegradable resin, in which the starch and resin are well miscible and the resultant composite resin has excellent biodegradability. Another object of the present invention is to provide an equipment used by said process.

The essential raw materials for the preparation of said biodegradable resin comprise thermoplastic resin, starch, liquid medium, coupling agent, lubricant, plasticizing agent and degradation promoter etc.

The thermoplastic resin is preferably selected from the group consisting of polyethylene, polypropylene, polystyrene, ethylene-vinyl acetate copolymer, polyester and polyamide.

The starch is preferably selected from the group consisting of corn starch, wheat starch, potato starch, sweet potato starch and tapioca starch.

The liquid medium is preferably selected from the group consisting of white oil and solvent oil.

The coupling agent is preferably selected from the group consisting of titanate coupling agent, aluminate coupling agent, silane coupling agent and aluminate-titanate compounded coupling agent.

The lubricant is preferably selected from the group consisting of stearate, stearic acid, polyethylene wax and oxidized polyethylene.

The plasticizing agent is preferably selected from the group consisting of dioctyl adipate, dioctyl sebacate and dioctyl phthalate.

The degradation promoter is preferably selected from the group consisting of corn oil and epoxidized soybean oil.

The technical solution of the present invention is described as follows.

The present process for the preparation of biodegradable resin comprises dehydrating a starch, finely granulating the starch, separating the starch from the liquid medium, modifying the separated starch, then blending the modified starch with the resin and then pelletizing the mixture. The detailed steps are follows:

(1) Dehydrating the Starch

The dehydrating of the starch is carried out by a dehydrating kettle to make the moisture content of the starch less than 0.5%, preferably 0.2-0.5%. The dehydrated starch and white oil or solvent oil is mixed homogeneously in a homogenizer at a weight ratio of 1:1-2, then the homogenized starch slurry is fed into the dehydrating kettle to remove water under a vacuum of 0.050-0.095 MPa and a temperature of 100-160° C. Preferably, said solvent oil is a solvent oil with boiling point of 150-220° C. under normal pressure.

(2) Finely Granulating the Starch

A group of sanders arranged in series are utilized to finely granulate the cooled starch slurry, so as to make the average granule size of the starch below 10 μm. Preferably, the granule size distribution is that the starch particles with granule size below 10 μm accounted for more than 80% by weight of the total weight of starch.

(3) Removing the Liquid Medium

The finely granulated starch is put into a separator such as a centrifuge, so as to remove the liquid medium and obtain a starch filter cake.

(4) Modifying the Starch

Said starch filter cake is put into a mixer, preferably a high-speed mixer with rotating speed from 1300 rpm to 1600 rpm. Then 0.5-5 wt % of a coupling agent and 0.5-7.5 wt % of a lubricant, based on the weight of the dehydrated starch, are added into the mixer to modify the starch. The obtained mixture is mixed at a temperature of 100-170° C. for 10-50 minutes to get a modified starch.

(5) Blending with a Thermoplastic Resin

The above modified starch, 25-80 wt % of a thermoplastic resin, 1-10 wt % of a plasticizing agent, 0.5-7.5 wt % of a lubricant and 1-15 wt % of a degradation promoter, based on the weight of the dehydrated starch, are fed into a mixer operated under room temperature, and blended together for a period of 10-30 minutes under stirring, and then the blended material is discharged.

(6) Extrusion-Pelletizing

Preferably, the above blended material is extrusion-pelletized via a twin-screw extruder the screws of which are mixing plasticizing screws having length to diameter ratio of 40-48:1, and having degassing function, or via the mixing extruder. The extrusion-pelletizing temperature is preferably of 100-290° C.

The present invention can be realized by the following preferred embodiments.

In the process for the preparation of said biodegradable resin, the starch is selected from the group consisting of corn starch, wheat starch, potato starch, sweet potato starch and tapioca starch.

In the process for the preparation of said biodegradable resin, the dehydrated starch slurry from hydrating kettle is cooled to a temperature below 60° C. in a cooling kettle.

In the process for the preparation of said biodegradable resin, the coupling agent is selected from the group consisting of titanate coupling agent, aluminate coupling agent, silane coupling agent and aluminate-titanate compounded coupling agent.

In the process for the preparation of said biodegradable resin, the lubricant is selected from the group consisting of stearate, stearic acid, polyethylene wax and oxidized polyethylene.

In the process for the preparation of said biodegradable resin, the thermoplastic resin is selected from the group consisting of polyethylene, polypropylene, polystyrene, ethylene-vinyl acetate copolymer, polyester and polyamide.

In the process for the preparation of said biodegradable resin, the thermoplastic resin is polyethylene selecting from the group consisting of high density polyethylene (HDPE), low density polyethylene (LDPE), linear low density polyethylene (LLDPE), mixture of HDPE and LLDPE and mixture of LDPE and LLDPE.

In the process for the preparation of said biodegradable resin, the plasticizing agent is selected from the group consisting of dioctyl adipate, dioctyl sebacate and dioctyl phthalate.

In the process for the preparation of said biodegradable resin, the degradation promoter is selected from the group consisting of corn oil and epoxidized soybean oil.

In the process for the preparation of said biodegradable resin, the finely granulating of starch is carried out continuously via 3-7 sanders arranged in series.

In the process for the preparation of said biodegradable resin, there is a two-stage degassing in the extrusion-pelletizing step. The two-stage degassing can decrease the volatile content in the product, so as to avoid the formation of air and water bubbles during the productions of film and fiber articles especially. The pelletizing step is carried out via chopping the extruded strands into pellets and air-cooling the pellets at the same time or via pulling the extruded strands through water and then chopping the cooled strands

The present invention possesses the following advantages and positive effects:

(1) The starch dehydrating technology utilized in the present invention can reduce the moisture content of the starch to less than 0.5%.

(2) The multiple-stage finely granulating technology of the present invention can make the average granule size of the starch ≦10 μm and the granularity of particles uniform, the result is that the surface area of the starch is increased and the quality of down-stream product thereof is ensured.

(3) The starch is modified by covering hydroxy group thereon via adding various modifiers, so that the hydrophilicity of the starch surface is reduced. Therefore, the dispersion of the starch in the matrix resin and thus its miscibility with the matrix resin of the starch are improved, and the content of the starch in the biodegradable resin and in final articles are increased.

(4) The quality of the biodegradable resin is ensured due to utilizing the mixing pelletizing equipment with screws having large length to diameter ratio and degassing function as well as special screw combination.

All of the above advantages mean not only that the resulted biodegradable resin has good biodegradability, but also that limited petroleum sources can be saved and the producing rate of polymer waste is greatly reduced. Furthermore, the addition of a majority of starch and degradation promoter in the present biodegradable resin facilitates composting treatment of the waste therefrom, which treatment is a particular recycle way and well meets the regulations for waste recycling.

The biodegradable resin can be widely used to produce disposable package materials, agricultural films, non-woven fabrics, injection and blowing molded articles, sheet articles, foamed articles and plant-breeding bowls etc.

For further understanding the technical contents, features and effects of the present invention, the following examples are listed and illustrated for detail.

### EXAMPLE 1

Industrial corn starch (1500 kg) and solvent oil (b.p. 155° C., at normal pressure) at a weight ratio of 1:1.5 were mixed uniformly in a homogenizer. The homogenized starch slurry was vacuum dehydrated in a dehydrating kettle under a vacuum of 0.08 MPa and a temperature of 120° C., until the moisture content of the starch was 0.35%. Then, the resulted starch slurry was put into a cooling kettle and cooled to a temperature of 56° C.

The cooled starch slurry was finely granulated via four sanders arranged in series, until the starch was finely granulated to an average granule size of 7.9 μm and the starch particles with granule size below 10 μm accounted for 85%.

The finely granulated starch slurry was put into a centrifuge to remove the liquid medium herein and obtain a starch filter cake.

The starch filter cake was fed into a high-speed mixer in multiple portions, with each portion of 150 kg of the starch filter cake. Then 1.5 kg of titanate coupling agent LICA38 and 1.5 kg of stearic acid lubricant were added into the mixer for modifying the starch. After mixing for a period of time of 20 minutes at 110° C., the modified starch was prepared.

The resultant modified starch, 75 kg of thermoplastic resin HDPE, 1.5 kg of dioctyl phthalate plasticizing agent, 1.5 kg of stearic acid lubricant and 3 kg of epoxidized soybean oil degradation promoter were fed into a mixer operated under room temperature and mixed together for a period of time of 20 minutes under stirring, and then the resultant mixed material was discharged.

The resultant mixed material was extrusion-pelletized via a mixing extruder at an extrusion-pelletizing temperature of 170-190° C. to obtain a biodegradable resin. The pelletizing was carried out via chopping the extruded strands into pellets and air-cooling the pellets at the same time. After the above working procedures, the biodegradable resin with excellent properties was prepared.

### EXAMPLE 2

Industrial potato starch (1500 kg) and industrial white oil at a weight ratio of 1:1.8 were mixed uniformly in a homogenizer. The homogenized starch slurry was vacuum dehydrated in a dehydrating kettle under a vacuum of 0.06 MPa and a temperature of 140° C., until the moisture content of starch was 0.45%. Then, the resulted starch slurry was put into a cooling kettle and cooled to a temperature of 50° C.

The cooled starch slurry was finely granulated via five sanders arranged in series, until the starch was finely granulated to an average granule size of 7.4 μm and the starch particles with granule size below 10 μm accounted for 89%.

The finely granulated starch slurry was put into a centrifuge to remove the liquid medium herein and obtain a starch filter cake.

The starch filter cake was fed into a high-speed mixer in multiple portions, with each portion of 150 kg of the starch filter cake. Then 3 kg of aluminate coupling agent DL-411 and 6 kg of polyethylene wax lubricant were added into the mixer for modifying the starch. After mixing for a period of time of 28 minutes at 120° C., the modified starch was prepared.

The resultant modified starch, 60 kg of thermoplastic resin polystyrene, 4.5 kg of dioctyl adipate plasticizing agent, 8 kg polyethylene wax lubricant and 6 kg of corn oil degradation promoter were fed into a mixer operated under room temperature and mixed together for a period of time of 12 minutes under stirring, and then the resultant mixed material was discharged.

The resultant mixed material was extrusion-pelletized via a twin-screw extruder the screws of which are mixing plasticizing screws having length to diameter ratio of 44:1, and having two-stage degassing function to obtain a biodegradable resin. The extrusion-pelletizing temperature was 200-230° C. The pelletizing was carried out via chopping the extruded strands into pellets and air-cooling the pellets at the same time. After the above working procedures, the biodegradable resin with excellent properties was prepared.

### EXAMPLE 3

Wheat starch (1500 kg) and industrial white oil at a weight ratio of 1:2 were mixed uniformly in a homogenizer. The homogenized starch slurry was vacuum dehydrated in a dehydrating kettle under a vacuum of 0.07 MPa and a temperature of 130° C., until the moisture content of starch was 0.3%. Then, the resulted starch slurry was put into a cooling kettle and cooled to a temperature of 55° C.

The cooled starch slurry was finely granulated via three sanders arranged in series, until the starch was finely granulated to an average granule size of 8.2 μm and the starch particles with granule size below 10 μm accounted for 83%.

The finely granulated starch slurry was put into a centrifuge to remove the liquid medium herein and obtain a starch filter cake.

The starch filter cake was fed into a high-speed mixer in multiple portions, with each portion of 150 kg of the starch filter cake. Then 1.2 kg of aluminate-titanate compounded coupling agent OL-AT1618 and 2 kg of magnesium stearate lubricant were added into the mixer for modifying the starch. After mixing for a period of time of 22 minutes at 160° C., the modified starch was prepared.

The resultant modified starch, 75 kg of thermoplastic resin ethylene-vinyl acetate copolymer, 3 kg of dioctyl sebacate plasticizing agent, 2 kg of magnesium stearate lubricant and 3 kg of corn oil degradation promoter were fed into a mixer operated under room temperature and mixed together for a period of 22 minutes under stirring, and then the resultant mixed material was discharged.

The resultant mixed material was extrusion-pelletized via a twin-screw extruder the screws of which are mixing plasticizing screws having length to diameter ratio of 40:1, and having two-stage degassing function to obtain a biodegradable resin. The extrusion-pelletizing temperature was 150-160° C. The pelletizing was carried out via chopping the extruded strands into pellets and air-cooling the pellets at the same time. After the above working procedures, the biodegradable resin with excellent properties was prepared.

### EXAMPLE 4

Sweet potato starch (1500 kg) and industrial white oil at a weight ratio of 1:1.2 were mixed uniformly in a homogenizer. The homogenized starch slurry was vacuum dehydrated in a dehydrating kettle under a vacuum of 0.095 MPa and a temperature of 160° C., until the moisture content of starch was 0.25%. Then, the resulted starch slurry was put into a cooling kettle and cooled to a temperature of 58° C.

The cooled starch slurry was finely granulated via seven sanders arranged in series, until the starch was finely granulated to an average granule size of 5.4 μm and the starch particles with granule size below 10 μm accounted for 92%.

The finely granulated starch slurry was put into a centrifuge to remove the liquid medium herein and obtain a starch filter cake.

The starch filter cake was fed into a high-speed mixer in multiple portions, with each portion of 150 kg of the starch filter cake. Then 4 kg of titanate coupling agent KR TTS and 3 kg of polyethylene wax lubricant were added into the mixer for modifying the starch. After mixing for a period of 30 minutes at 140° C., the modified starch was prepared.

The resultant modified starch, 45 kg of thermoplastic resin polyester, 7.5 kg of dioctyl phthalate plasticizing agent, 3 kg of polyethylene wax lubricant and 4.5 kg of epoxidized soybean oil degradation promoter were fed into a mixer operated under room temperature and mixed together for a period time of 30 minutes under stirring, and then the resultant mixed material was discharged.

The resultant mixed material was extrusion-pelletized via a twin-screw extruder the screws of which are mixing plasticizing screws having length to diameter ratio of 48:1, and having two-stage degassing function to obtain a biodegradable resin. The extrusion-pelletizing temperature was 270-290° C. The pelletizing was carried out via chopping the extruded strands into pellets and air-cooling the pellets at the same time. After the above working procedures, the biodegradable resin with excellent properties was prepared.

### EXAMPLE 5

The same procedures as described in Example 1 were followed, except that the starch used was tapioca starch, the coupling agent for modifying starch was silane coupling agent KH570, the modifying temperature was 150° C., the thermoplastic resin was polypropylene, the extruder was a twin-screw extruder the screws of which are mixing plasticizing screws having length to diameter ratio of 48:1, and having two-stage degassing function, the pelletizing was carried out via pulling the extruded strands through water and then chopping the cooled strands, the extrusion-pelletizing temperature was 150-170° C., so as to obtain a biodegradable resin with excellent properties.

### EXAMPLE 6

The same procedures as described in Example 2 were followed, except that the lubricant utilized both in the step for modifying starch and in the step for blending starch with thermoplastic resin was oxidized polyethylene, the thermoplastic resin was polyamide, the pelletizing was carried out via pulling the extruded strands through water and then chopping the cooled strands, the extrusion-pelletizing temperature was 230-280° C., so as to obtain the biodegradable resin with excellent properties.

We claim:

1. A process for the preparation of biodegradable resin, comprising the following steps:
(1) mixing uniformly a starch and white oil or solvent oil in a homogenizer and then vacuum dehydrating the homogenized starch slurry to a moisture less than 0.5% in a dehydrating kettle;
(2) finely granulating the cooled starch slurry to an average granule size below 10 μm;
(3) removing the liquid medium in the finely granulated starch slurry to obtain a filter cake;
(4) mixing in a mixer the resultant starch filter cake with 0.5-5 wt % of a coupling agent and 0.5-7.5 wt % of a lubricant, based on the weight of dehydrated starch, to modify the starch;
(5) mixing the resultant starch with 25-80 wt % of a thermoplastic resin, 1-10 wt % of a plasticizing agent, 0.5-7.5 wt % of a lubricant and 1-15 wt % of a degradation promoter, based on the weight of dehydrated starch, in a mixer operated under room temperature;
(6) extrusion-pelletizing the resultant mixed material.

2. The process for the preparation of biodegradable resin according to claim 1, wherein step (1) is carried out by mixing uniformly the starch and white oil or solvent oil at a weight ratio of 1:1-2 in the homogenizer, then vacuum dehydrated the homogenized starch slurry in the dehydrating kettle under a vacuum of 0.05-0.095 MPa and a temperature of 100-160° C.

3. The process for the preparation of biodegradable resin according to claim 1, wherein finely granulating starch in step (2) is carried out in a group of sanders arranged in series.

4. The process for the preparation of biodegradable resin according to claim 1, wherein the temperature for modifying starch in step (4) is 100-170° C. and the mixing time is 10-50 minutes.

5. The process for the preparation of biodegradable resin according to claim 1, wherein the mixing time of the modified starch with the thermoplastic resin and said other components in step (5) is 10-30 minutes.

6. The process for the preparation of biodegradable resin according to claim 1, wherein said resultant mixed material in step (6) is extrusion-pelletized via a twin-screw extruder with mixing plasticizing screw or via a mixing extruder.

7. The process for the preparation of biodegradable resin according to claim 6, wherein said screws of twin-screw extruder have length to diameter ratio of 40-48:1 and are of degassing function, the extrusion-pelletizing temperature is 100-290° C.

8. The process for the preparation of biodegradable resin according to claim 1, wherein the starch is selected from the group consisting of corn starch, wheat starch, potato starch, sweet potato starch and tapioca starch.

9. The process for the preparation of biodegradable resin according to claim 1, wherein the dehydrated starch slurry is cooled in a cooling kettle to a temperature of below 60° C.

10. The process for the preparation of biodegradable resin according to claim 1, wherein the coupling agent is selected from the group consisting of titanate coupling agent, aluminate coupling agent, silane coupling agent and titanate-aluminate compounded coupling agent.

11. The process for the preparation of biodegradable resin according to claim 1, wherein the lubricant is selected from the group consisting of stearate, stearic acid, polyethylene wax and oxidized polyethylene

12. The process for the preparation of biodegradable resin according to claim 1, wherein the thermoplastic resin is selected from the group consisting of polyethylene, polypropylene, polystyrene, ethylene-vinyl acetate copolymer, polyester and polyamide.

13. The process for the preparation of biodegradable resin according to claim 1, wherein the plasticizing agent is selected from the group consisting of dioctyl adipate, dioctyl sebacate and dioctyl phthalate.

14. The process for the preparation of biodegradable resin according to claim 1, wherein the degradation promoter is selected from the group consisting of corn oil and epoxidized soybean oil.

15. The process for the preparation of biodegradable resin according to claim 3, wherein the finely granulating of the starch is consecutively carried out by using 3-7 sanders arranged in series.

16. The process for the preparation of biodegradable resin according to claim 7, wherein there is a two-stage degassing in the extrusion-pelletizing step, the pelletizing is carried out via chopping the extruded strands into pellets and air-cooling the pellets at the same time or via pulling the extruded strands through water and then chopping the cooled strands.

17. The process for the preparation of biodegradable resin according to claim 12, wherein the thermoplastic resin is polyethylene selecting from the group consisting of high density polyethylene, low density polyethylene, linear low density polyethylene, a mixture of high density polyethylene and linear low density polyethylene, and a mixture of low density polyethylene and linear low density polyethylene.
